(19) United States
(12) Patent Application Publication
(10) Pub. No.: US 2010/0283868 A1
(43) Pub. Date: Nov. 11, 2010

(54) Apparatus and Method for Application of Selective Digital Photomontage to Motion Pictures

(76) Inventors: Lloyd Douglas Clark, San Francisco, CA (US); Brian A. Brown, San Francisco, CA (US)

Correspondence Address: LLOYD DOUGLAS CLARK, 15 CONRAD ST., SAN FRANCISCO, CA, 94131, US

(21) Appl. No.: 12/748,412

(22) Filed: Mar. 27, 2010

(51) Int. Cl. H04N 5/228; H04N 5/232; H04N 5/76

(52) U.S. Cl. 348/231.4; 348/345; 348/222.1; 348/E05.045; 348/E05.031

(57) ABSTRACT

A system for taking motion pictures of a scene with different parts at different focal lengths with a camera that normally would not have sufficient depth of field to capture all parts of said scene in focus. A computer (610) controls a high-speed, digital camera (605) and a lens (600) with rapid focus capability to produce a stack of images at different focal lengths for rapid processing into a composite serial image montage stream in motion picture output format (625). Operator controls permit continuous selection of depth of field (DOF) in the output image and enable a plurality of in-focus and out-of-focus regions over the depth of an image. An optional output port (640) provides for real-time recordation of all images in each stack for later processing. An optional remote control (1015) duplicates the main controls in the camera system (1000) so that a second person can assist in optimizing images as they are recorded, or for remote control of the camera itself. An audio input (645) and an optional digital data input (650) are provided for sound and cueing.

### BACKGROUND

1. Field

The field is digital photographic cameras, in particular motion picture cameras and cameras with rapid image recording capability.

2. Prior Art

FIGS. 1 through 5

A photomontage is a composite image comprising combined sections of each image in a set, or stack, of source images. In the discussion below, the source images are related in that they share the same general subject matter, but have sections that comprise different focal distances.

Lenses of all kinds are well-known to have limited depth of field (DOF), i.e., an image will be in focus for only part of the distance between the front of the lens and infinity. For example, a lens can focus on an object at a middle distance, but objects very near and very far away will be out of focus. Digital photography has made it possible to make a montage in which part or all of the image is in perfect or near-perfect focus. Such a technique is popularly called “focus stacking”.

In focus stacking, a plurality of images, called a “stack”, is taken seriatim at selected focal distances that are spaced so that the DOF of the lens at each focal distance overlaps the DOF at the next, adjacent focal distance. Then each image is examined for its in-focus parts and those parts are placed into a composite image.

In one scenario, a composite image starts with a first image in a stack, for example the image nearest the camera. The first image may contain in-focus and out-of-focus parts. Next, the infocus parts of a second image in the stack are identified and pasted into the composite image, replacing the out-of-focus parts, and so forth for all the selected images in the stack. This process can be done manually or in software. Doing it in software gives rise to image processing by a number of different complex mathematical techniques. In some cases this process introduces image artifacts. These are easily removed in the final composite image.

Prior-art FIGS. 1-4 show how a selection of images taken at different focal distances are assembled to provide a final composite image that is in focus at all parts of the composite image, regardless of their distances from a camera. A scene 100 is imaged by a camera 105 with a lens 110. Lens 110 has a limited or relatively short depth of field (DOF) or in-focus area as indicated in FIG. 1. In this example, there are nine overlapping DOF zones, numbered 1 through 9. Nine photos are taken at nine different focal distances, from close (zone 1, where the camera may be set to focus at one or two meters from the camera), to distant (zone 9, where the camera may be set to focus at 30 meters to infinity from the camera). Zones 1-9 are shown as equal length for the purposes of illustration, however they vary in extent, becoming longer as distance away from the front of the lens increases, as explained below.

In FIG. 1, the in-focus parts of a stack of images taken at all the DOF zones, 1-9, are assembled into a composite image. After finding and adding all the in-focus parts of all nine images to the composite image, the final composite image is in focus at all distances within DOF zones 1-9.

Instead of an all-in-focus composite image, isolating one or more DOF zones in a stack permits an operator to selectively emphasize parts of a composite picture by keeping those parts in focus in the composite image, while de-emphasizing the remainder of the picture by leaving the remaining areas out of focus. FIGS. 2 through 4 show how this is done.

In FIG. 2 only DOF zone 1 is included in the final composite image. Thus the parts of zone 1 that are in focus are emphasized in the final composite comprising this one image, while the remainder of the composite image is out of focus.

In FIG. 3, only DOF zones 7-9 are included in the composite image. Thus zones 1-6 will be out of focus while DOF zones 7-9 are in focus.

FIG. 4 contains two DOF zones that are in focus separated by one DOF zone that is out of focus. Images taken in DOF zones 1-2 and 5-9 are included in the composite image while the images from zones 3 or 4 are not included. The result is a final composite image with zones 1-2 and 5-9 that are in focus and zones 3-4 that are out of focus. Many combinations and permutations are possible.

Focus stacking can be done manually with the aid of a computer program that selects the infocus pixel areas in a stack of images. Suitable programs are Photoshop and others sold by Adobe Systems Incorporated, of San Jose, CA. It can also done semi-automatically with a program such as Helicon Focus, sold by Helicon Soft, Ltd. of Kharkov, Ukraine. Both techniques work very well for still photos.

An example of a prior art apparatus and method is shown in FIG. 5. The setup comprises a digital camera 105, such as the model D300S manufactured by Nikon Corporation of Japan, a lens 110 affixed on camera 105, a computer 500 that runs software that controls camera 105 and lens 110 during the taking of a stack of pictures 505, and additional software 510. Software 510 is arranged to find the in-focus parts of each picture in stack 505 and combine the in-focus parts into a final composite image 515 that is delivered as output 520. The output is normally stored on the computer's hard disk (not shown) in a standard still image file format such as JPG, TIFF, or the like. These steps are provided in the Helicon Focus computer program, mentioned above.

It would be desirable to provide the same capability for use in capturing motion pictures; however presently available techniques are much too slow.

### SUMMARY

We have discovered a method and apparatus that makes focus stacking possible at a rate that is high enough for use in motion picture photography, i.e., an output composite picture rate of at least 24 frames per second. Our method and apparatus also make it possible to select in real time one or more regions of focus within the camera's full depth capability, while deliberately leaving other regions out of focus. These capabilities place focusing entirely in the hands of the camera operator. Alternatively, part or all of the focusing can be done after the moving picture images are recorded in memory.

### DRAWING FIGURES

FIGS. 1-4 show a prior-art arrangement with selectable DOF regions for inclusion in a composite image.

FIG. 5 shows a block diagram of a prior-art setup for processing a focus stack to create a high depth-of-field still photo.

FIG. 6 shows a block diagram of one aspect of a preferred embodiment.

FIG. 7 shows a flow chart of operation of the embodiment of FIG. 6.

FIGS. 8 and 9 show primary and secondary control displays, respectively, according to the embodiment of FIG. 6.

FIG. 10 shows a camera according to an alternative embodiment that has a remote control.

FIG. 11 shows a camera viewing a scene according to one aspect of an alternative embodiment.

FIGS. 12 through 14 show various alternative aspects of displays of images taken with the embodiment of FIG. 11.

FIG. 15 shows the display of FIG. 12 according to a third alternative embodiment.

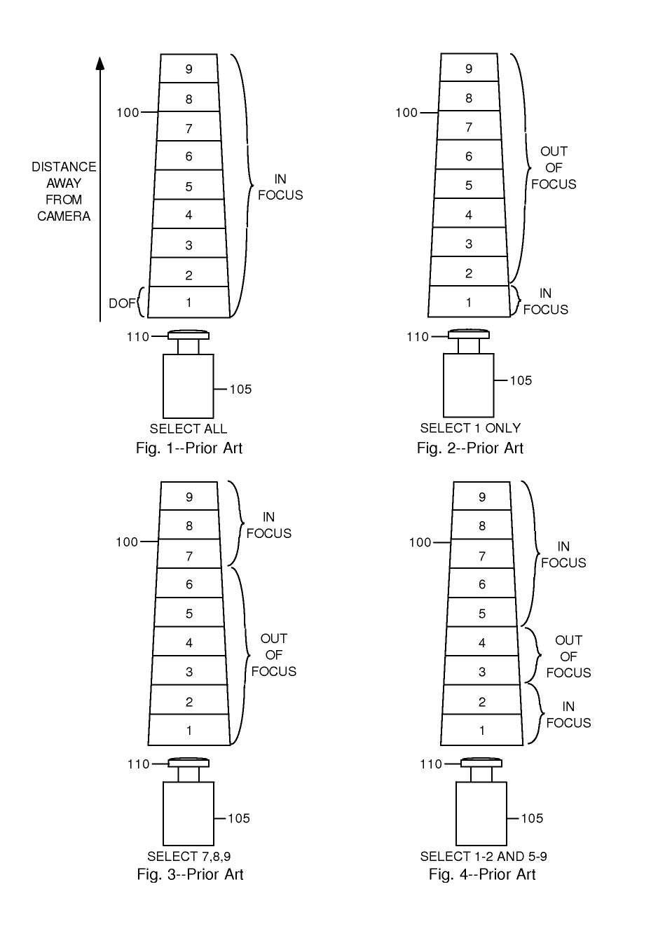

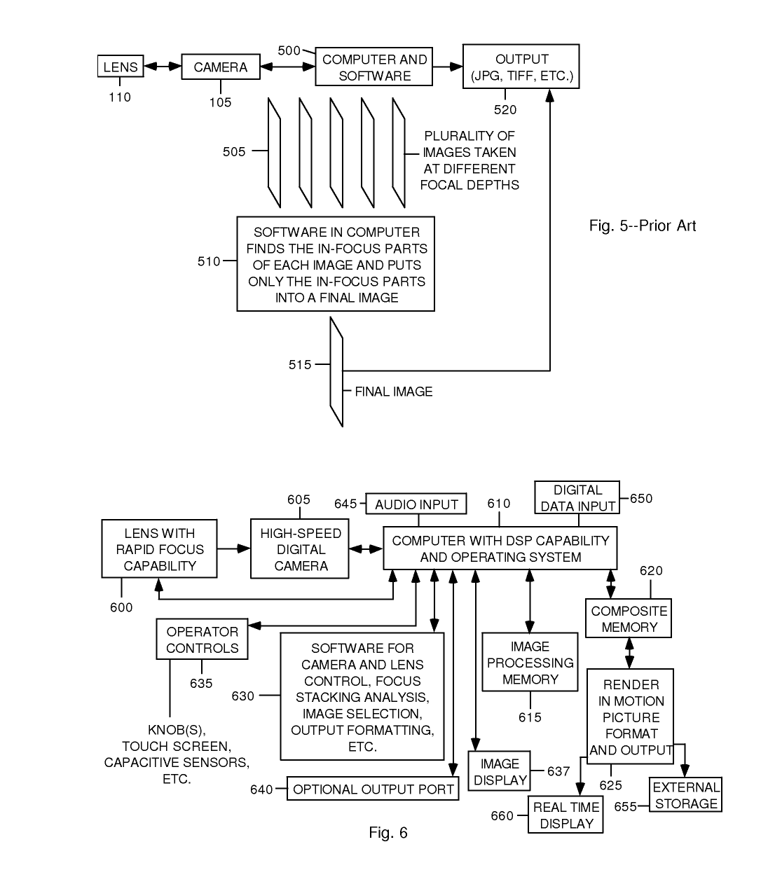

### DRAWING FIGURE REFERENCE NUMERALS

100 Scene

105 Camera

110 Lens

500 Computer

505 Stack

510 Software

515 Image

520 Output

600 Lens

605 Camera

610 Computer

615 Image Processing Memory

620 Composite Memory

625 Terminus

630 Software

635 Controls

640 Output

645 Audio Input

650 Digital Data Input

660 Real-time display

700-775 Blocks

800 Primary Control Display

900 Secondary Control Display

1000 Camera

1015 Control

1020 Conduit

1100 Scene

1200 Object

### ABBREVIATIONS

AVI, WMV: Video formats for Microsoft Windows operating system

BMP: Bitmap

DSP: Digital Signal Processing

FPS: Frames Per Second

FPGA: Field Programmable Gate Array

GIF: Graphics Interchange Format

JPEG: Joint Photographic Experts Group

MOV: QuickTime video format for Apple operating system

MPG, MPEG: Motion Picture Experts Group

RAM: Video format by RealVideo Corporation

PIXEL: Picture Element

TIFF: Tagged Image File Format

### FIRST EMBODIMENT

### Description

FIGS. 6 through 9

FIG. 6 shows a block diagram of one aspect of a first embodiment of a camera capable of storing and outputting near-real-time composite images that are distilled from a stack of images. A lens 600 with rapid focusing capability delivers images to a high-speed digital camera 605. Lens 600 and camera 605 operate under control of a computer 610 that has fast digital signal processing (DSP) capability. While most computers are capable of digital signal processing, many are incapable of the speeds required by this embodiment unless they also have additional, dedicated circuitry to rapidly perform repetitive tasks for image processing. This well-known circuitry is found on accessory, plug-in boards for computers and in specially designed DSP chips as discussed below.

Computer 610 contains software 630 for camera and lens control, focus stacking image analysis, selection of image sections from the focus stack, composite collecting and formatting software, and an operating system such as one sold under the trademark Windows by Microsoft Corporation of Redmond, WA, or Macintosh, sold by Apple Computer of Cupertino, CA. Alternatively the Linux operating system that is generally open-sourced, or a customized system, can be used. Computer 610 also has an image processing memory 615 and a composite memory 620 which can be separate memories or partitions within a single memory. Memories 615 and 620 can be either a semiconductor memory or a hard disk memory.

An output terminus 625 formats and delivers the final image output to a storage medium 655 such as a digital or analog tape, film, hard disk, flash memory, and the like, and also to a near-real-time (delayed by one frame time or the time it takes to assemble each composite image) display 660. The composite output images are preferably streamed to final storage medium 655 in order to reduce the memory requirement of the embodiment, although internal storage media (not shown) may be used if required. High speed communication among the various components is supplied by fast digital communication protocols and hardware, including but not limited to fiber optics. A set of operator controls 635 permits the camera operator to at least vary the depth of field in the composite image, select regions of focus and non-focus within the composite image, select the number of images in a stack, to vary focus-stacking mathematical parameters, adjust the frame rate, and to turn the focus stacking capability of the camera ON and OFF. An image display 637 displays the image at preselected processing stages to the camera operator, as is explained below.

Lens 600 and camera 605 can be optimized for use in the infrared, visible, and ultraviolet parts of the electromagnetic spectrum. Camera 605 can be a monochrome, i.e. grayscale or black-and-white, camera or a color camera, and can have any number of optical sensing elements ranging from a few thousand to many million.

The DOF is a function of the focal length and aperture of lens 600 and of the sensor in camera 605. It can be calculated by computer 610 so that the number of overlapping DOF distances from the front of the camera to the farthest point of interest can be used to calculate the number of images required to form a complete stack.

Requirements: Rate of Image Capture, Analysis, Combining, and Storage

In order to produce flicker-free motion pictures, images must be updated at a rate of at least 24 frames per second (FPS). Thus, in order to produce a focus stack with two focal depths such as near and far, a frame rate of at least 48 FPS is required. In practice, it is desirable to have more than two focal depths available.

### Image Capture Rate:

The following example assumes five overlapping DOF regions and an output frame rate of 25 FPS. The actual input frame rate, i.e., the rate of image capture by camera 605 and refocusing by lens 600, is determined by the output frame rate times the number of DOF regions plus the overhead time required by computer 610 to perform all of its functions. Thus a digital camera capable of a frame rate of greater than 125 FPS is required. Many digital cameras are available with very high frame rates. An example is the model FASTCAM-Ultima APX-RS, manufactured by Photron USA, Inc., of San Diego, CA, with a frame rate of 3,000 FPS.

### Lens Refocus Rate:

In the present example, lens 600 must be able to focus at a new distance faster than 125 times per second in order to meet the 125 FPS rate. Thus lens 600 must be able to focus at a new distance within 8 milliseconds. One such lens is described in a paper by Oku and Ishikawa in the proceedings of the Lasers and Electro-Optics Society meeting of 2006, ISBN 0-7803-9555-7. Two separate chambers are joined by an orifice. A first fluid having a first index of refraction fills a lower chamber, a second fluid, immiscible with the first and having a different index of refraction from the first, fills an upper chamber. A piezoelectric actuator squeezes the first chamber, causing the interface between the two fluids to bulge by a predetermined amount. Since the two fluids have different indices of refraction, a lens with controllable curvature is formed in the orifice. Their variable-focus lens is actuable to selectable focal distances and has a 2-millisecond response time. This type of lens accepts commands from computer 610 in order to focus at predetermined distances.

An alternative lens type continuously cycles through its focal range. I.e., the lens is actuator-driven and cyclically focuses from a predetermined near point to a predetermined far point. In this case, the lens provides a periodic synchronization signal to indicate when it is at a particular focal distance. Computer 610 receives the synchronization signal and performs its focus stacking computations based on a priori knowledge of the distance at which lens 600 is focused.

### Analysis and Combining Rate:

Computer 610 must be able to receive and process images from camera 605 at a high rate of speed. Image processing comprises receiving the image data, organizing the data (i.e., arranging it in image form for processing), performing filtering, normalizing, and correction functions if required, performing focus stacking operations (possibly including Fast Fourier transforms, resizing algorithms, matrix mathematics, etc., depending on the algorithms used), and outputting the image to composite memory 620.

In the present example, camera 605 comprises a color imaging device such as a CMOS imager, a Foveon brand sensor, or a Charge Coupled Device (CCD) with one megapixel for each color plane, red, green, and blue (RGB). Thus it would employ 1,024 pixels in each of X and Y directions for a total of 3.072 megapixels). The pixel transfer rate from camera 605 to computer 610 will be 125 FPS×3.072×10⁶=384 megapixels/sec=48 megabytes/sec, not counting overhead such as resetting the imaging device, data transfer handshaking, etc. Computer 610 must be able to process data in excess of this rate. This is readily done using DSP chips (integrated circuits), field programmable gate arrays (FPGA), multi-core processors, bit-slice processors and the like. DSP chips are particularly fast and well-suited to this application. They are available from a variety of manufacturers. For example, the MSC8112 through MSC8156-series DSP chips from Freescale Semiconductor of Austin TX can perform between 2,400 and 48,000 million 16-bit multiply-accumulate operations per second. Depending on the focus stacking software used and the number of images in a stack, these data rates are more than adequate.

Focus stacking analysis, i.e., finding the in-and out-of-focus loci in an image, will require most of the data processing time and capability of computer 610. After focus stacking analysis and processing, the images are simply combined into the composite image on a pixel-by-pixel basis which is simple addition and scaling. If required, some of the computational and control requirements such as lens control, etc. can be off-loaded to a second computer (not shown).

Additional image processing steps may be required to remove image artifacts that result from the manipulation of the images. These artifacts are seen as halos around regions of high contrast and distortions at the edges of the final images. The latter can be removed by cropping the image. Halos can be reduced by adjusting various parameters in the focus stacking algorithms.

In addition, exposure levels may need to be adjusted since the amount of light detected by camera 605 is potentially decreased by a factor equal to the number of frames in the stack. Whether exposure levels require adjustment depends on the effective shutter speed of the camera. I.e., in the case of the above example, if the effective shutter speed of the camera is one millisecond, then either none or only minimal exposure compensation will be required. However, if the effective shutter speed of the camera is on the order of 42 milliseconds, as is possible in the case of 24 frame-per-second photography, then exposure compensation may be required in order to increase the brightness of the image to its proper level. Compensation is accomplished by adjusting the sensitivity of the sensor in camera 605. This is typically done by adjusting the gain in the amplifiers that receive the sensor's signals before passing the signals to computer 610. This function is automated within computer 610.

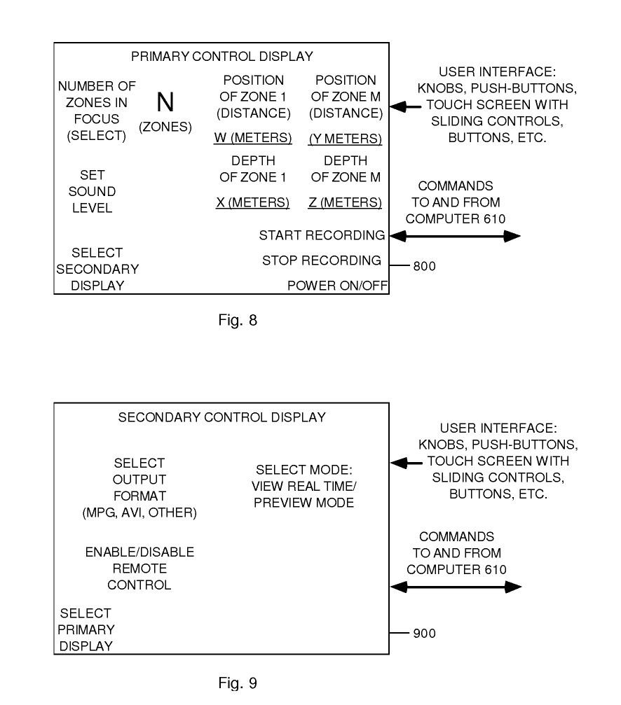

Image display 637 comprises an eyepiece display or a larger display such as a liquid crystal display (LCD), organic light-emitting diode display, etc. on camera 605. Under the control of computer 610 and selected on either of displays 800 or 900 (FIGS. 8 and 9), display 635 shows the final image in composite memory 620 or in final motion picture format as it is available in block 625. Alternatively, it can show one or more selected images from the focus stack in image processing memory 615.

An optional output port 640 delivers each image in the stack to an external device (not shown) that records or accepts all images in each stack for later processing by either computer 610 or an external computer (not shown).

An audio input 645 is included with the camera for recordation of sound with the scene being recorded. Sound data from audio input 645 is processed by computer 610 or another stand-alone computer (not shown) and added to the motion picture format output from block 625. In addition, digital data such as cue signals for later output as well as previously recorded stack images from output port 640 are input to computer 610 through digital data input 650.

Operation Flow Chart

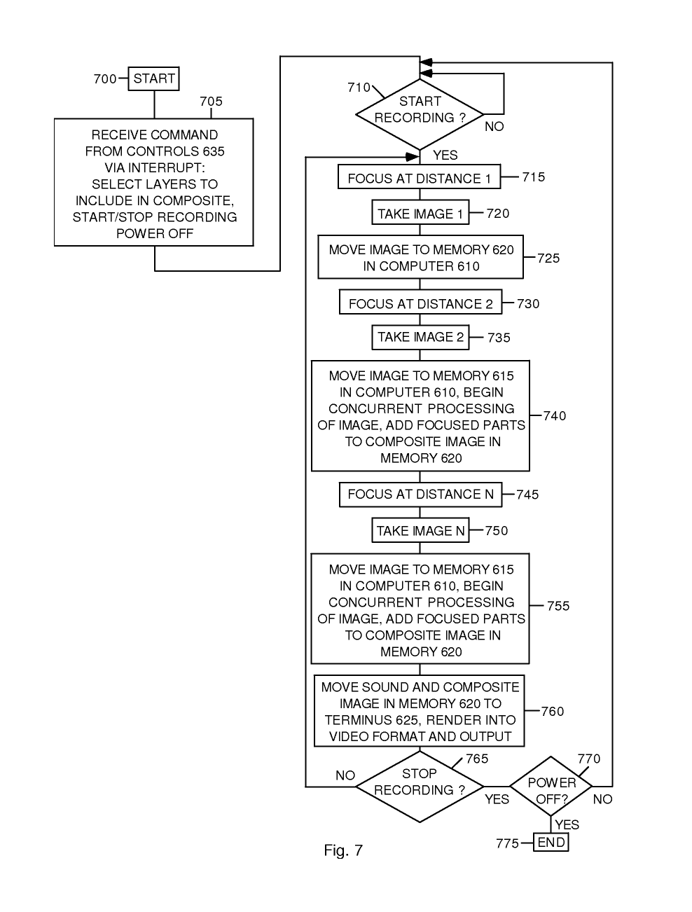

FIG. 7

FIG. 7 is a flow chart showing how computer 610 processes images as they pass through the system of FIG. 6.

At the start, block 700, the camera operator applies power to the system of FIG. 6. Computer 610 initializes all of its functions and then receives commands from controls 635 via program interrupts, well-understood by those familiar with computer programming. The user accesses controls 635 to select which DOF layers to include in the stack for processing. This can be all layers or one or more subsets of the layers.

In an alternative aspect to the present embodiment, controls 635 include a plurality of knobs that are actuable at any time during operation of the system. A first knob is used to select the position of a first focal distance; a second knob is used to select the number of DOF fields that surround the first focal distance; a third knob is used to select a second focal distance; a fourth knob selects the number of DOF fields that surround the second focal distance, and so forth. Thus by simply turning knobs, the operator can place the entire stack in focus in the final composite image, or select one or more regions within the stack that are in focus, while leaving the rest of the image in an unfocused condition.

To commence recording the user accesses a start command, block 710. Computer 610 causes lens 600 to focus at a first predetermined distance, say 8 m, in a stack, block 715, and then take a first image, block 720. The first image is moved to memory 620 and forms the basis of the final composite image. This first image, and all subsequent images, each constitute a single frame or picture which is in focus at the selected distance

Next, computer 610 causes lens 600 to focus at the second focal distance, say 11 m, in the stack, block 730, take an image there, block 735, and move the image to memory 615. This refocusing of lens 600 takes place in less than 125 ms. In memory 615 software 630 in computer 610 looks for in-focus parts of the current image and adds them to the composite image in memory 620 on a pixel-by-pixel basis, block 740.

This process continues with computer 610 causing lens 600 to focus at each selected successive distance, say two more distances of 17 m and 36 m and to finally focus at the last distance, n, say infinity, in the stack, block 745, take the n^{th} image, block 750, and move the n^{th} image to memory 615 for processing and adding to the composite image in memory 620, block 755.

In some cases, the second and subsequent images are slightly displaced with respect to the first image and their size may be slightly different. The focus stacking image analysis software detects these differences and scales and orients the second and subsequent images to fit with the first image. This is well-known to those skilled in the art of focus stacking.

With all images in the stack processed and added to the composite image, the composite image motion picture frame and its associated sound are moved to output memory 620, block 760, where they are streamed to an external storage unit 655 such as a hard disk, film, tape, flash memory, and the like, and also to display 660 for viewing by the camera operator. Computer 610 can also instruct output terminus 625 to format the picture and sound information into any of the standard video and moving picture formats such as MPG, AVI, WMV, MOV, RAM, custom, etc. Computer 610 can also optionally cause output terminus 625 to format picture information in any normally still picture format such as GIF, JPEG, TIFF, BMP, and the like. It should be noted that although these formats are normally used for storage and presentation of still pictures, pictures taken in these formats can also be appended serially to form motion pictures. These single frames from the camera make it possible to take one or a series of still photos using the rapid image capture ability of the camera. This is useful when taking stacked pictures of transient phenomena such as live insects, moving mechanical parts, and the like.

With the stack operation complete, the operator can stop recording, block 765, or continues recording whereupon control returns to block 715. Alternatively, the operator can power the camera OFF, block 770, in which case operations are at an end, block 775. In the absence of the power OFF command, control reverts to block 710 and the program awaits further instructions.

Instead of instructing lens 600 to return to the first focal distance for each subsequent frame, the next stack can work backward from the present focal distance in order to save time and wear and tear on the focus mechanism. I.e., for a first frame, the stack can be compiled of focal distances ranging from far to near and in the next frame from near to far, and so forth. Alternatively, images in the stack can be taken in any order, however they are preferably processed by the focus stacking software in near-to-far or far-to-near order to permit proper scaling of images for inclusion in the final composite image.

As mentioned above, instead of instructing lens 600 to focus at predetermined distances, lens 600 can optionally cycle through the entire range of desired depths and by commutation notify computer 610 when it has reached a particular focal distance, whereupon computer 610 instructs camera 605 to take the next picture.

FIGS. 8 and 9 show representative displays of camera control functions. FIG. 8 shows a primary function display 800 of the camera in which the operator can view and choose the number of zones of best focus, N, and their properties. The display can be an LCD or Organic Light Emitting Diode (OLED) screen on the camera with the functions and parameters indicated in different parts of the screen. The operator touches or presses a button or turns a knob that increments or decrements N on the display and in the software operating in computer 610. When N=1, full focus-stacking can be in effect, depending on the setting of the “Depth of Zone 1” control. If the depth of zone 1 is set at a maximum value, then all the overlapping DOF fields are included. This may include the entire field of view if all DOF zones overlap over the entire depth of the image. Multiple DOF zones are useful when the operator wishes to emphasize objects in predetermined zones by ensuring that the objects are in focus in the final composite, while leaving the remainder of the composite image out of focus. This is useful for producing artistic effects and to isolate a region of interest (ROI) from the rest of the scene.

If the depth of zone 1 is set to a lesser value, then the “Position of Zone 1” control is in effect and fewer than all the DOF zones are included in the stack. The result is an image that is in focus over a range of depths determined by the “Depth of Zone 1” control, and out of focus at other depths. The in-focus region can move from the nearest DOF range to the farthest as this control is moved from one extreme to the other.

When N=2, a second zone is in focus. The distance over which this zone is in focus is moved and sized as with zone 1. There can be additional zones, M, as desired.

In addition to zone selections, the operator activates controls to start and stop recording of images and to turn the camera ON and OFF from this screen.

FIG. 9 shows a secondary control display 900 that is selected from primary display 800. Secondary control display 900 is selected by touching or otherwise activating the command “Select Secondary Display” in the lower left-hand corner of display 800. Alternatively, the display of FIG. 9 can be a separate screen. When secondary control display 900 is active, the operator selects other operational functions such as the output format (AVI, BMP, GIF, JPEG, MOV, MPG, RAM, TIFF, WMV, custom, etc.), enables or disables remote control of the camera's functions (discussed below), and selects real time or preview modes (also discussed below). When finished with the secondary control display, the operator selects the primary display to continue operation of the camera.

All functions on displays 800, 900, and any additional displays communicate with computer 610, issuing commands to computer 610 and receiving signals back from computer 610. Received signals include updating of the parametric values on displays 800, 900, and any other additional displays.

All controls comprise either manually operated or touch screen knobs, buttons, and sliding controls. Some are preferably located on or adjacent the primary and secondary control displays. Others are located where they will be most easily reached by the operator. For example, the START RECORDING and STOP RECORDING controls are preferably located on an exterior part of the camera (not shown) where the operator's hand normally rests.

### FIRST ALTERNATIVE EMBODIMENT

Remote Control

Decription and Operation

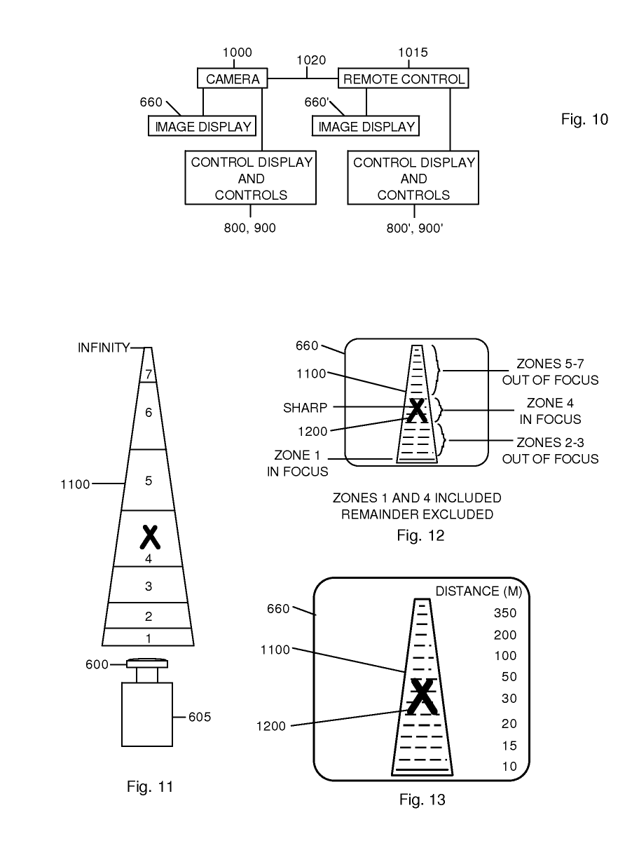

FIG. 10

In a first alternative embodiment remote control of the taking and processing of sound and images is provided so that a director, designer, editor, or another person or even an appropriately programmed computer can select features and adjust desired camera function settings in real time as recording is taking place.

FIG. 10 shows a camera 1000 with image display 660 and control display 800 or 900, as described above. A remote control unit 1015 is connected to camera 1000 and therefore to computer 610 by a conduit 1020. Conduit 1020 is an electrical connection, an optical fiber for communication between camera 1000 and control 1015, or a combination thereof. Remote control unit 1015 preferably has an image display 660′ and a control display and controls 800′, 900′ that have some or all of the same capabilities and functionality as those of 635, 800, and 900, respectively. This permits the camera operator to concentrate on capturing the scene while the person operating remote control 1015 concentrates on optimizing the scene as it is being recorded.

### SECOND ALTERNATIVE EMBODIMENT

DOF Identification, Distance Indication, and Discerning Partially Hidden Objects

FIGS. 11 through 14

### DOF Calculation

The number of parameters required for calculation of the DOF depends on the precision required for a particular situation. A very simple calculation includes the hyperfocal distance (HFD), the diameter of the circle of confusion (COC), the f-stop of the lens (F), and the focal length (FL) of the lens. These variables are well known to those skilled in the art of photography. The HFD is defined for a lens that is focused at infinity. It is the distance from the front of the lens beyond which all objects are in focus. The COC diameter is a human physiological value that represents the diameter of a circle visible to most people at a predefined distance and under predefined conditions. A representative value is 0.2 mm, although this depends further on scaling of the initial image. F is the focal length of a lens divided by its effective aperture diameter.

The following is a simple formula for determining DOF at a distance D away from the front of the lens. The limits of DOF are a near point (NP), i.e. the nearest point of focus within the DOF, and a far point (FP), i.e. the farthest point of focus within the DOF.

DOF =FP−NP, where

FP =(HFD×D)/(HFD−D), and

NP =(HFD×D)/(HFD +D), where

HFD =FL² /(F×COC).

It can be seen from these equations that DOF is not a linear function of distance. At greater distances, the size of DOF increments become larger. These equations are valid only over a certain range. The image is in focus for all D values equal to or greater than HFD.

In certain situations, the DOF is limited to small increments over a scene. For example, if lens 600 (FIG. 6) has a focal length of 205 mm and the f-stop of the lens is f/3.4, the DOF at 10 meters is 3 meters. If a stack of images has a desired in-focus field extending from 10 meters to infinity, then the first in-focus region, zone 1, extends from 9 to 12 m; zone 2 extends from 10 to 15 m; zone 3 extends from 12 to 19 m; zone 4 extends from 15 to 28 m; zone 5 extends from 19 to 52 m; zone 6 extends from 28 to 343 m, and zone 7 extends from less than 343 m to infinity.

### DOF Identification and Distance Indication

FIG. 11 shows a scene 1100 comprising 7 zones, as determined by the above calculation. This calculation indicates that a stack comprising 7 zones is required to result in a composite image that is in focus over the full depth of the scene. Thus computer 610 instructs lens 600 (FIG. 6) to focus at a first predetermined distance for a first image in the stack and camera 610 to take a first image there, then a second, and so forth until all images are combined in a composite image. This all-in-focus composite image can be recorded in external storage 655 or viewed in real time on display 660. In FIG. 12, display 660 shows the all-in-focus composite image of scene 1100 containing an object of interest 1200.

In one method for determining the approximate distance from lens 600 to object 1200 the user simply views individual zones in scene 1100 one-at-a-time. Object 1200 will be out of focus in all zones except zone 4. The distance from lens 600 to object 1200 is thus determined from the above calculations, i.e. object 1200 lies between the near point and the far point of zone 4.

A more accurate determination of the distance from lens 600 to object 1200 can be obtained by adding more zones and noting the far point of a particular zone at which object 1200 just comes into focus.

More intensive calculations can provide even more accurate results. Programs such as Helicon Focus, mentioned above, produce a depth map that gives the distance into a scene for each pixel in the composite image.

Distance indication is provided by computer 610 and optionally included in the composite image for display on display 660 or recordation in external storage. FIG. 13 shows an example of the appearance of display 660 with distance information included.

### Discerning Partially Hidden Objects

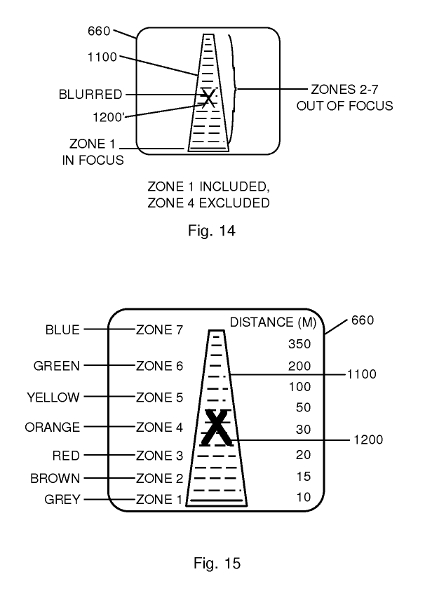

FIG. 14 shows an object of interest 1200′ that is partially hidden in zone 4 of scene 1100. To better discern object 1200′, the camera operator alternately includes then excludes each zone in scene 1100, one-at-a-time until object 1200′ is found. This is done by viewing the composite image on display 660, leaving zone 1 in the composite image and including zone 2 for a short period, then excluding zone 2 for a short period, and repeating this including and excluding while all other zones are excluded from the composite image. Each short period lasts about one second. Computer 610 can be programmed to perform this function, if desired.

If object 1200′ is not found in zone 2, then the remaining zones are viewed in the same on-off way. When zone 4 is reached, object 1200′ will appear in and out of focus as zone 4 is included and excluded from the composite image on display 660. The relative presence and absence of object 1200′ in the composite image helps the camera operator to recognize and localize it.

### Additional Capabilities

If a sufficiently high-resolution depth map of an object is available, a simulated 3-dimensional composite image of an object can be generated. The simulated 3D image can be viewed from slightly different angles, providing insight into the nature of the object. Commercially available software uses depth information to produce well-known anaglyphs, i.e. pairs of images comprising two slightly different perspective views of an object. These are viewed with crossed eyes or specialized glasses.

### THIRD ALTERNATIVE EMBODIMENT

False Color Images

FIG. 15

FIG. 15 shows the appearance of scene 1100 and object 1200 in display 660 according to one aspect a third alternative embodiment. False colors can be added to the composite image in display 660 in order to improve understanding of scene 1100 or for artistic effects. Computer 610 can be programmed to cause display 660 to show each zone in a different color, for example. In another aspect of the present embodiment, rough areas on object 1200 can be displayed in one color and smooth areas in another color. All colors from black to white, i.e. brown, blue, etc., can be used as desired to augment the display of objects 1200 in scene 1100. In another aspect, the composite image on display 660 can be inverted either in grayscale or complimentary colors. For example, when object 1200 is in reality red, it can be displayed as blue or green.

Conclusion, Ramifications, and Scope

Accordingly the reader will see that, according to one or more aspects, we have provided an improved motion picture camera system that gives the operator complete control over focus as the motion picture images are being viewed and optionally recorded.

While the above description contains many specificities, these should not be construed as limitations on the scope, but as exemplifications of some presently preferred embodiments. For example, a remote control enables a second person to optimize the image recordation process. Audio and cue points are added to the output, either the optional output port or the motion picture format output, as desired. The camera system is preferably portable, but can be moved robotically if required. The remote control capability permits operating the camera system in remote, underwater, hostile, etc. environments at some distance from the operator. The camera can be attached to a microscope, a binocular, a monocular, or a telescope. The camera can be mounted on a pivot in order to photograph a panorama.

Many other ramifications and variations are possible within the teachings. For example, many aspects of operation of the preferred embodiment can be reduced to single integrated circuits. Instead of knobs, touch screens, and the like, voice control of the camera can be used. Because of the depth of field information, limited three-dimensional images can be created from a stack. These can be exported as a series of images that can be viewed from different angles or as anaglyphs. The anaglyphs can comprise polarized or bi-color left and right images. Instead of refocusing for each image in a stack, all images in a stack can be taken at the same focal distance and position and then averaged in order to increase the dynamic range of the camera. Instead of refocusing the lens for each image in a stack, the focal distance is kept constant and the camera is moved toward or away from the object as the stack is being recorded in memory. Objects in each image taken this way will vary in size, but focus stacking software can remove this variation in the final composite image.

Thus the scope should be determined by the appended claims and their legal equivalents, and not by the examples given.

1. A system for focus stacking for motion picture taking, comprising: a lens with rapid refocus rate capability, a digital camera with high frame rate image capture capability, an image display, a storage means for storing frames captured by said camera, computer means and software responsive to operator controls for controlling said camera and
said lens, collecting a stack of images, performing focus stacking image analysis on said
stack, creating a composite image from the in-focus parts of said stack in memory,
rendering said image into motion picture format, and outputting said image to said
storage means at a predetermined frame rate, wherein said refocus rate and said frame rate are sufficiently high as to permit said computer
means to repetitively perform said collecting, said performing, said creating, said
rendering, and said outputting at a predetermined frame rate equal to or greater than that
required for flicker-free motion picture viewing.

2. The apparatus of claim 1, further including an audio input for said computer means, said computer means arranged to process said audio input into sound that is included in the output of said computer means.

3. The apparatus of claim 1 wherein said computer means has a digital signal processing capability.

4. The apparatus of claim 3 wherein said digital signal processing capability is provided by means selected from the group consisting of DSP chips, FPGAs, bit-slice logic, and multi-core processors.

5. The apparatus of claim 1 wherein said motion picture format is selected from the group consisting of AVI, BMP, GIF, JPEG, MOV, MPG, RAM, TIFF, WMV, and custom formats.

6. The apparatus of claim 1, further including an output port for outputting images for real-time recordation.

7. The apparatus of claim 1, further including remote control means.

8. The apparatus of claim 1 wherein said image display is selected from the group consisting of eyepiece displays and flat-screen displays.

9. A method for focus stacking for motion picture recordation, comprising: providing a lens with rapid focusing capability, providing a digital camera with high frame rate image capture capability, providing computer means and software operational in said computer means that is responsive to
operator controls for controlling said camera and said lens and capturing images seriatim
from said camera in order to form a stack of said images, providing a memory for said computer means, providing an output terminus capable of formatting an image into a motion picture frame and
outputting said frame to external storage means, collecting a stack of images in said memory, performing focus stacking image analysis on said stack, creating a composite image from the in-focus parts of said stack in said memory, formatting said composite image into motion picture format, outputting said image to a storage means at a predetermined frame rate, activating said computer means to operate said lens and said camera and perform said collecting,
said performing, said creating, said formatting, and said outputting steps, whereby a series of said frames is repetitively conveyed from said lens, through said stack, into
said composite image, and output to said external storage means in said motion picture
format at said predetermined frame rate.

10. The method of claim 9 wherein said frame rate is at least 24 frames per second.

11. The method of claim 9, further including providing an audio input for said computer means and capability within said computer means for combining said audio output with said composite image in said motion picture format.

12. The method of claim 9, further including a digital data input for inputting cue signals to aid computer means.

13. The method of claim 9, further including an output port for outputting said stack of images seriatim.

14. The method of claim 9 wherein said computer means is arranged to command said lens to focus at a predetermined distance for taking an image for said stack.

15. The method of claim 9 wherein said lens can operates independently and send commutation signals representative of the focal distance of said lens to said computer means in order for said computer means to selectively record images at predetermined focal distances for inclusion in said stack.

16. The method of claim 9, further providing a remote set of operator controls so that said motion picture recordation can be done remotely.

17. The method of claim 9 wherein said computer means further includes a digital signal processing capability provided by means selected from the group consisting of DSP chips, FPGAs, bit-slice logic, and multi-core processors.

18. A system for selectively controlling the number, extent, and depth of focal zones for a motion picture camera, comprising: a lens, a digital camera, a computer having a memory and arranged to cause said lens to focus seriatim at a plurality of
predetermined distances, to cause said camera to record an image at each distance, to
store a stack of said images in said memory, and perform focus stacking operations on
said images to provide a composite image, said computer further including means to format said composite image into a frame in motion
picture format and output said frame to an external display or storage device, said computer being arranged to perform said recording, said stacking, said formatting, and said
outputting of said frames at motion picture frame rates.

19. The system of claim 18 wherein said lens and said camera are optimized for use with wavelengths selected from the group consisting of visible, infrared, and ultraviolet.

20. The system of claim 18 wherein said composite image is arranged to include distance indication.

21. The system of claim 18 wherein said computer is arranged to cause said display to show or said storage device to record false-color images.
